(19) United States
(12) Patent Application Publication
(10) Pub. No.: US 2016/0224969 A1
(43) Pub. Date: Aug. 4, 2016

(54) SYSTEMS AND METHODS FOR FACILITATING A FINANCIAL TRANSACTION

(71) Applicant: Adam Kuo-Tung Hwang, Sugar Land, TX (US)

(72) Inventor: Adam Kuo-Tung Hwang, Sugar Land, TX (US)

(21) Appl. No.: 15/011,577

(22) Filed: Jan. 31, 2016

Related U.S. Application Data
(60) Provisional application No. 62/110,551, filed on Feb. 1, 2015.

(51) Int. Cl. G06Q 20/32; G06F 3/0482; G06Q 20/38

(52) U.S. Cl. CPC G06Q 20/3224; G06Q 20/381; G06F 3/0482

(57) ABSTRACT

Techniques involve receiving requestor currency exchange information from a portable electronic device, generating an option list, and transmitting the option list to the portable electronic device. The option list may be generated based on the requestor currency exchange information, a location of the portable electronic device, and a location of potential exchangers in the option list. The requestor currency exchange information includes types and amounts of currency to be given and received in the currency exchange and/or currency exchange rates. Generating the option list involves dynamically adjusting the option list based on the location of the portable electronic device and/or potential exchangers in the option list. Techniques may also involve displaying a transaction coordination screen on the portable electronic device to facilitate a financial transaction. The transaction coordination screen may include dynamically updated information related to locations of the portable electronic device and one or more potential exchangers.

### CROSS-REFERENCE TO RELATED APPLICATIONS

This application claims priority under 35 U.S.C. §119(e) to U.S. Provisional Patent Application Ser. No. 62/110,551, entitled SYSTEMS AND METHODS FOR FACILITATING A FINANCIAL TRANSACTION, filed on Feb. 1, 2015, the content of which is incorporated by reference herein in its entirety for all purposes.

### BACKGROUND

The present invention relates generally to financial transactions. More particularly, the present invention relates to techniques for facilitating a financial transaction for a mobile device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions.

In the current global network, there are many types of financial transactions, and even more existing techniques for effecting such financial transactions. For example, one type of financial transaction involves the exchange of one currency for a different type of currency. For instance, a traveler may wish to exchange United States Dollars for European Euros to use the accepted European currency when traveling in various European countries. Such a currency exchange transaction may typically be completed at a bank, at an automated teller machine (ATM), or at a currency exchange office. Alternatively, the traveler may use traveler's checks or cashier checks and then locate a retailer or official able to exchange the check for suitable currency.

While various techniques exist for effecting commercial transactions such as currency exchanges, such techniques may be costly, inconvenient, or time consuming. Banks that are willing and able to offer a desired currency exchange may not be open during convenient times and may not be located in convenient locations. Furthermore, ATMs often charge a transaction fee for each cash withdrawal or use an unfavorable exchange rate to provide a currency exchange.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Some embodiments of the present technique involve receiving, from a portable electronic device, a request comprising requestor currency exchange information, generating an option list, and transmitting the option list to the portable electronic device. The option list may be generated based on the requestor currency exchange information, a location of the portable electronic device, and a location of potential exchangers in the option list.

In some embodiments, the requestor currency exchange information includes a first type of currency to be given in a currency exchange and a second type of currency to be received in the currency exchange, an amount of the first type of currency to be given, an amount of the second type of currency to be received, an amount range of the first type of currency to be given, an amount range of the second type of currency to be given, a currency exchange rate, a currency exchange rate range for the currency exchange, or combinations thereof.

Generating the option list in some embodiments is based on exchanger currency exchange information received from the potential exchangers, where the second type of currency to be exchanged with the first type of currency, an amount of the second type of currency to be exchanged, or both. The exchanger currency exchange information may further include one or more of an amount of the first type of currency to be received, a currency exchange rate, or a currency exchange rate range for the currency exchange. In some embodiments, generating the option list involves dynamically adjusting the option list based on the location of the portable electronic device and/or dynamically adjusting the option list changes based on the location of potential exchangers in the option list. Generating the option list may involve dynamically adjusting the option list based on real-time updates in the location of the portable electronic device and real-time updates in the location of the potential exchangers and may also be based on a proximity of the location of the potential exchangers to the location of the portable electronic device.

In some embodiments, the method may include displaying a transaction coordination screen on the portable electronic device, once a potential exchanger from the option list is selected by the portable electronic device, where the transaction coordination screen includes dynamically updated information related to a first location of the portable electronic device and a second location of the selected potential exchanger. Displaying the transaction coordination screen may include displaying a dynamically updated map displaying the first location and the second location and movement of the first location and movement of the second location. Displaying the transaction coordination screen may also include displaying a chat interface suitable for allowing exchange of messages between the portable electronic device and a potential exchanger. In some embodiments, the map and the chat interface may be either displayed simultaneously, or may be suitable for toggling between the screens.

In some embodiments, generating the option list is performed by a processor at a server in communication with the portable electronic device and the potential exchangers. Furthermore, in some embodiments, generating the option list is performed by a processor of the portable electronic device.

Some embodiments involve a method of facilitating a transaction between a first portable electronic device and potential transacting devices. The method involves receiving a first transaction request from the first portable electronic device and generating an option list. In some embodiments, the option list may be based on the first transaction request, transaction information from the potential transacting devices, a location of the first portable electronic device, and a location from the potential transacting devices. The method also transmitting the option list to the first portable electronic device. The method further includes displaying a transaction coordination screen on the first portable electronic device and a potential transacting device when the first portable electronic device selects the potential transacting device from the offer list and dynamically updating a map of the transaction coordination screen with a first geolocation of the first portable electronic device and a second geolocation of the potential transacting device.

One or more embodiments involve a method including receiving a first transaction request from a first portable electronic device and receiving a second transaction request from a second portable electronic device, a second transaction request. The method includes generating an option list based on the first transaction request, the second transaction request, a location of the first portable electronic device, and a location of the second portable electronic device. The method also involves transmitting the option list to one or more of the first portable electronic device and the second portable electronic device.

Various refinements of the features noted above may be made in relation to various aspects of the disclosure. Further features may also be incorporated in these various aspects as well. These refinements and additional features may exist individually or in any combination. For instance, various features discussed below in relation to one or more of the illustrated embodiments may be incorporated into any of the above-described aspects of the disclosure alone or in any combination. The brief summary presented above is intended just to familiarize the reader with certain aspects and contexts of embodiments of the disclosure without limitation to the claimed subject matter.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates a schematic diagram of a financial transaction system involving one or more portable electronic devices in accordance with one or more example embodiments.

FIG. 2 illustrates a block diagram of a portable electronic device which may be used in accordance with one or more example embodiments.

FIG. 3 illustrates a block diagram of a host server system in accordance with one or more example embodiments.

FIG. 4 illustrates a flow chart of a method for facilitating a financial transaction in accordance with one or more example embodiments.

FIG. 5 illustrates flow chart of a method for dynamically updating location information between a plurality of portable electronic devices in accordance with one or more example embodiments.

### DETAILED DESCRIPTION

One or more specific embodiments of the present disclosure will be described below. These described embodiments are just examples of the presently disclosed techniques. Additionally, in an effort to provide a concise description of these embodiments, features of an actual implementation may not be described in the specification. It should be appreciated that in the development of any such actual implementation, as in any engineering or design project, numerous implementation-specific decisions may be made to achieve the developers' specific goals, such as compliance with system-related and business-related constraints, which may vary from one implementation to another. Moreover, it should be appreciated that such a development effort might be complex and time consuming, but would still be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

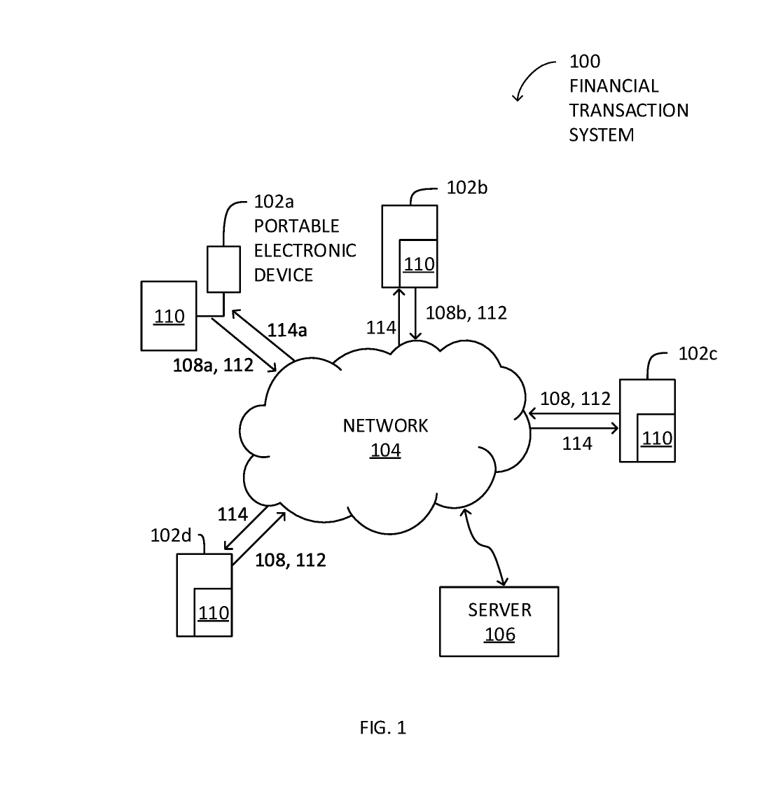

One or more embodiments of the present technique relate to facilitating potential financial transactions between one or more portable electronic devices. FIG. 1 is a schematic diagram of a financial transaction system 100 involving one or more portable electronic devices 102, in accordance with one or more embodiments of the disclosure. As used herein, the electronic device 102 may refer to user inputs made on the device 102, communications to and from the device 102, and/or a user using or associated with the device 102.

The financial transaction system 100 includes a network 104 (such as, for example, a wired or wireless internet connection, cellular data plan, etc.) and portable electronic devices 102 suitable for accessing the network 104. The financial transaction system includes a server 106 suitable for communicating with a plurality of portable electronic devices 102 via the network 104.

Each of the portable electronic devices 102 is suitable for submitting a transaction request 108, which may be received at the server 106. For example, the financial transaction system illustrated in FIG. 1 provides an example scenario where the device 102a submits a transaction request 108a. The transaction request 108a may be made, for example, through an application 110 such as an installable or downloadable application, a website, etc., in some embodiments. In accordance with the present techniques, the application 110 may be any suitable interface through which a portable electronic device 102 may communicate a transaction request 108 to the server 106 and/or for the server 106 to communicate with an electronic device 102. The transaction request 108 may include, for example, a request to receive a type and/or an amount of currency, an offer to exchange the requested type and/or amount of currency for another type and/or amount of currency, or both. As used herein, currency may include various currencies or monetary equivalents in various countries, sovereign states, territories, entities, or any monetary unit primarily used in any geographic region. Currency may also include alternative currencies, digital currencies and cryptocurrencies, such as Bitcoin. The present techniques may be applicable for facilitating potential financial transactions between any suitable currencies.

In some embodiments, before or while a device 102 is accessing and/or communicating with the server 106, the server 106 may have access to geographical location information 112 of the device 102. In some embodiments, the server 106 may first request permission to access the geographical location information 112 or provide an option for the device 102 to provide its geographical location information 112. In one or more embodiments, the application 110 may automatically have access to the geographical location information 112 of the device 102 once the device 102 installs and/or accepts such terms of the application 110 on the device 102.

The financial transaction system 110 may be suitable for transmitting a transaction option list 114 to a device 102. A transaction option list 114 may include a list of other requests from one or more other devices 102. In some embodiments, the option list 114 may be based on a geographical location of a requesting device 102 (e.g., device 102a) and/or geographical locations of other requesting devices 102 (e.g., device 102b, 102c, etc.). For example, options associated with requests from other devices 102b, 102c may be part of an option list 114a transmitted to device 102a based on the geographical locations of the devices 102b, 102c with respect to that of device 102a. In some embodiments, a device 102b, 102 is geographically proximate to a device 102a if it is within approximately a 1 mile by 2 mile area (or approximately a 1 mile by 1 mile area, or approximately a 0.5 mile by 0.5 mile area, etc.) around device 102a. In other embodiments, a device 102b is geographically proximate to a device 102a if it is within approximately a 1 mile radius (or approximately a 2 mile radius, or approximately a 0.5 mile radius, etc.) around 102a. Other distance or area thresholds may be suitable in accordance with embodiments of the present disclosure.

The transaction option list 114 may also be based on what a device 102 is requesting and/or offering. For example, the device 102a may be requesting European Euros and offering US Dollars. The options for option list 114a may include requests 108 from other devices 102 requesting Dollars and offering Euros. For example, device 102c may also be requesting Euros and offering Dollars, and as such, may not be a compatible option for device 102a and an option associated with device 102c may not be on the option list 114a for device 102a. A device 102b may be requesting Dollars and offering Euros and as such, an option associated with device 102b may be a compatible option for device 102a and may be an option on the option list 114a for device 102a.

In some embodiments, in addition to a type of currency requested (e.g., Euros, Dollars, etc.) a requested amount or an offered amount may also be included in a request 108 and may affect an option list 114. In some embodiments, a requested and/or offered amount may be an exact number or a range. For example, device 102a may request 100 Euros and offering 130 US Dollars in some embodiments, and may receive offers corresponding to this request 108a. Furthermore, some embodiments may involve ranges of requested amounts and/or offered amounts. For example, device 102a may request 95-105 Euros and offering 120-140 US Dollars in exchange. Furthermore, in some embodiments, a request 108 may also include a currency exchange rate (e.g., a rate of 1.3 USD to Euro) or a range of acceptable currency exchange rates (e.g., a rate of 1.28-1.32 USD to Euro). Such information regarding an amount of currency to be received and/or offered may affect the options generated or transmitted in the transaction option list 114. In some embodiments, a device 102 may send multiple requests substantially in parallel. For example, in some embodiments, the application 110 may allow a user of a device 102 to select multiple types of currency to give and/or to receive or multiple ranges for the exchange, and these requests may be sent in one or more requests 108 to the server 106.

In some embodiments, the transaction option list 114 may be continuously and/or dynamically updated, based on changes in location of the devices 102 and/or updates in transaction requests 108. For example, the list 114 transmitted to device 102c may be dynamically updated while a device 102c is requesting and/or waiting to select an option to complete a financial transaction. The device 102c may move away from other devices 102a or 102b such that the device 102c is no longer geographically close enough to a device 102a or 102b to complete a financial transaction through the financial transaction system 100. Different options may be available for the device 102c based on where the device 102c has moved. Likewise, if the device 102b moves away from the device 102c, the request of device 102b may no longer be an option for the device 102c and may be removed from the option list 114c transmitted to the device 102c.

The list 114c transmitted to the device 102c may also be dynamically updated based on updates in transaction requests 108. For instance, if device 102a accepts an offer from device 102b, the request of 102a and/or 102b that has been completed may be removed from all other option lists 114, such as the option list 114c transmitted to device 102c. Similarly, a new request from a device 102d may be added to the option list 114c transmitted to the device 114c at any time while the device 114c is waiting for a suitable option.

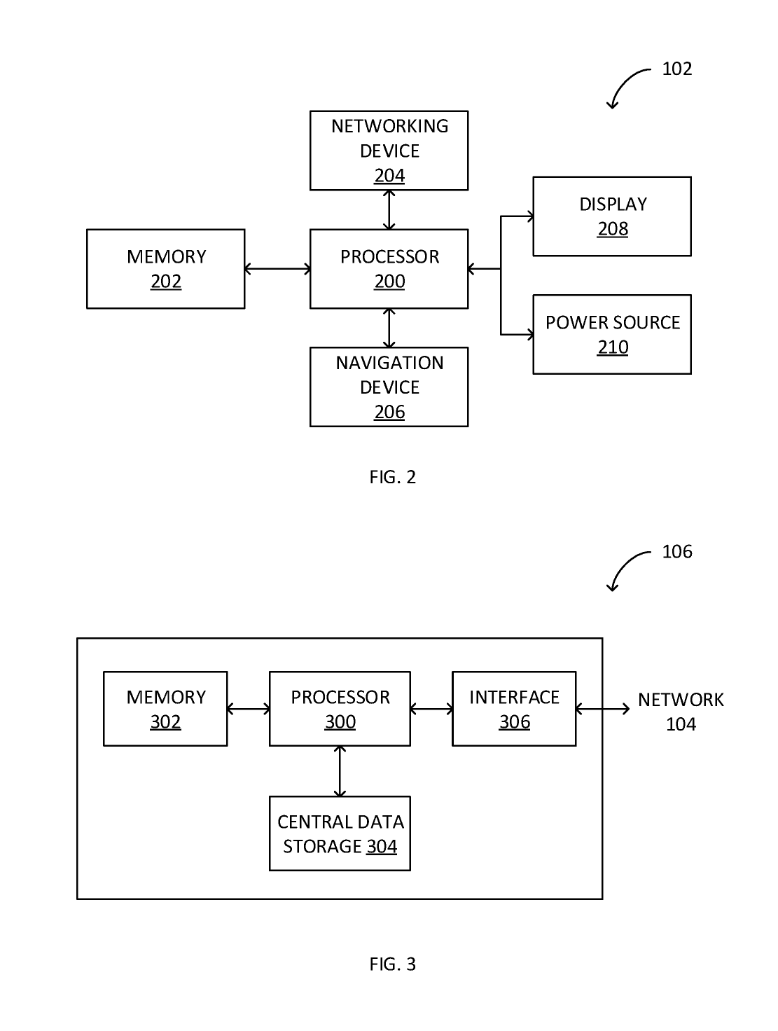

A portable electronic device 102 may be any device suitable for accessing the network 104 and being substantially portable, such as, for example, a mobile or cellular phone, a laptop, a tablet device, etc. The block diagram illustrated in FIG. 2 represents a portable electronic device 102 suitable for use in accordance with the present techniques of facilitating potential financial transactions and includes components that may be present in one such electronic device 102. Those of ordinary skill in the art will appreciate that the various functional blocks shown in FIG. 2 may include hardware elements (including circuitry), software elements (including computer code stored on a computer-readable medium, such as a hard drive or system memory), or a combination of both hardware and software elements. FIG. 2 is only one example of a particular implementation and is merely intended to illustrate the types of components that may be present in the electronic device 102. For example, in the presently illustrated embodiment, these components may include one or more processors 200, one or more memory devices 202, a networking device 204, a navigation device (e.g., GPS functionality) 206, a display 208, and a power source 210.

The processor(s) 200 may provide the processing capability required to execute the operating system, programs, application, user interface, and any other functions of the device 102. The processor(s) 200 may include one or more microprocessors, such as one or more “general-purpose” microprocessors, a combination of general and special purpose microprocessors, and/or ASICS. In some embodiments, the processor(s) 200 may be suitable for executing instructions or applications related to a financial transactions in accordance with some embodiments, as will be further discussed.

Embodiments of the electronic device 102 may also include a memory 202. The memory 202 may include a volatile memory, such as RAM, and/or a non-volatile memory, such as ROM. The memory 202 may store a variety of information and may be used for a variety of purposes. For example, the memory 202 may store the firmware for the device 102, such as an operating system for the device 102, and/or any other programs or executable code necessary for the device 102 to function. In addition, the memory 202 may be used for buffering or caching during operation of the device 102. For example, the memory 202 may be suitable for storing instructions or program code for an application 110 for effecting or facilitating a financial transaction, as well as any instructions or data needed to run the application 110 and/or facilitate a financial transaction, such as a dynamically updated option list 114, for example. In some embodiments, execution of the application 110 by the processor 200 may result in, for example, generation of user interface screens facilitating a location-based financial transaction, as will be further described.

In some embodiments, the electronic device 102 includes a networking device 204, which may include, for example, a wireless transceiver, which includes but is not limited to a Wi-Fi adapter, a cellular data antenna, Bluetooth®, near field communication (NFC), etc. The portable electronic device 102 may be capable of, via its networking device 204, communicating with other devices or elements within a network (e.g., network 104). In some embodiments, the electronic device 102 may be capable of communicating with other devices 102 and/or a server (e.g., server 106) via its networking device 204. The networking device 204 may be suitable for enabling a financial transaction between one or more portable electronic devices 102, in accordance with some embodiments.

The processor 200 may also be in communication with a navigation device 206 that is suitable for any known means of location detection, such as by using global positioning system (GPS) functionality, cell phone tower triangulation, IP address-based geolocation, etc., or any combination of these techniques. In some embodiments, the navigation device 206 may communicate location information to an application programming interface (API), through which other applications or processes in the device 102 may access the location information of the device 102. For example, an application 110 for facilitating a location-based financial transaction may access the API for location information provided by the navigation device 206.

The display 208 may be used to display various images generated by the electronic device 102. The display 208 may be any suitable display, such as a liquid crystal display (LCD) an organic light-emitting diode (OLED) display, etc. Additionally, in certain embodiments of the electronic device 102, the display 208 may be provided in conjunction with a touch-sensitive element, such as a touch-screen, that may be used as part of the control interface for the device 102. In some embodiments, the display 208 may be suitable for displaying various screens related to facilitating a location-based financial transaction. For example, the display 208 may be suitable for displaying a user interface associated with an application 110 used for facilitating financial transactions in accordance with embodiments of this disclosure. Furthermore, a touch-screen of the display may be suitable for controlling and/or inputting requests or selections associated with the application 110.

FIG. 3 illustrates a block diagram of a host server system 106 in accordance with one or more example embodiments. The host server system 106 includes one or more processor modules 300 in communication with one or memory modules(s) 302. The memory module(s) 02 will typically include code executable by the processor modules 300 to effect a location-based financial transaction in accordance with some embodiments of this disclosure. The host server system 106 further includes a central data store 304 containing information concerning or otherwise relating to users of the devices 102. The exchange of information between the central data store 304 and the user devices 102 is facilitated by one or more network interfaces 306 in communication with elements of network 104. Administrative personnel or system operators may interact the server system 106 by way of user interface elements, such as through applications 110, and/or remotely via an interface 306 of the network 104.

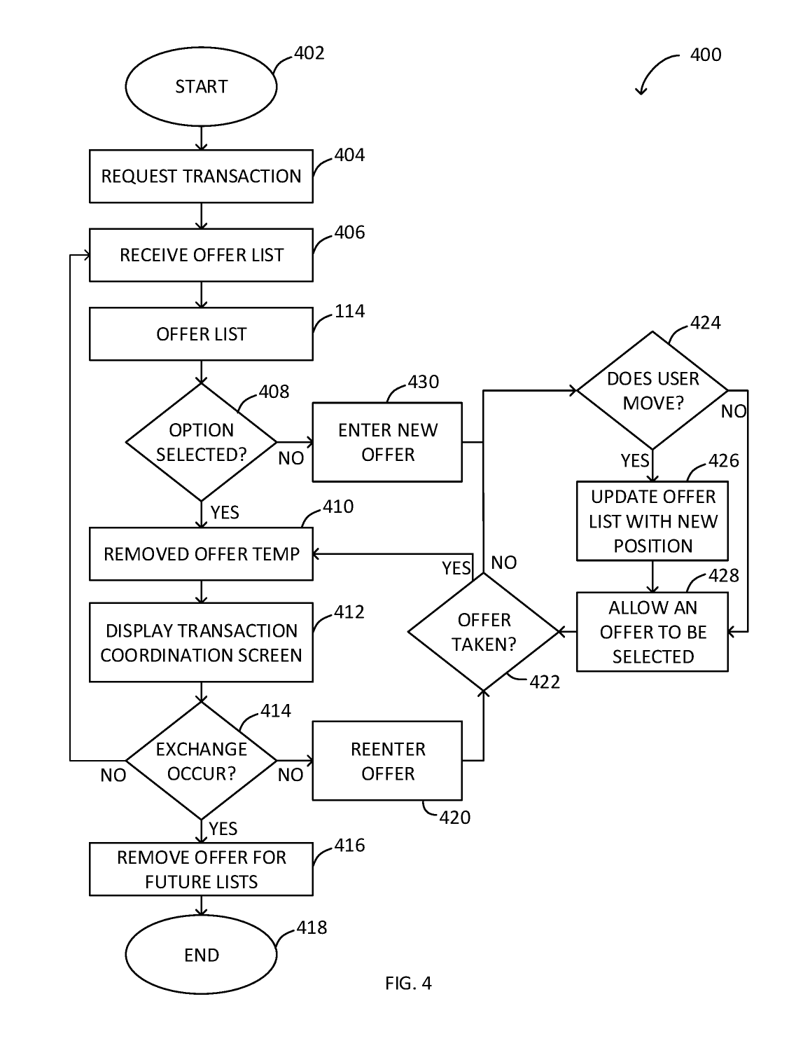

A method for facilitating a location-based financial transaction in accordance with some embodiments is provided in the flow chart illustrated in FIG. 4. The method 400 begins (block 402) with an electronic device (e.g., 102a) requesting (block 404) a transaction (e.g., transaction request 108a). In some embodiments, the transaction request may involve selecting an offered currency and/or a requested currency, and in some embodiments, requesting (block 404) a transaction may further involve offering an exact amount or range of the offered currency and/or requesting an exact amount or a range of the requested currency. Furthermore, in some embodiments, requesting (block 404) a transaction may involve selecting an exact exchange rate or inputting a range of an acceptable exchange rate.

The electronic device 102 may then receive (block 406) an offer list (e.g., 114) including a list of options corresponding with the transaction request 108. In some embodiments, the transaction request 108 may be sent to a server 106 through a network 104, and the server 106 may send the offer list 114 back to the electronic device 102 through the network. Furthermore, an offer list 114 may include a list of complementary or suitable offers, with respect to a type and/or amount of a currency being offered and/or requested. In some embodiments, an offer list 114 may be displayed as a list, as tiles, in a map view, or combinations of these types of displays. For example, the offer list 114 may be interchangeably switched between a list view or a map view, where the list view includes a list of sortable and/or filterable options, and where the map view includes points of the estimated geographical locations of other devices 102 having complementary or suitable offers.

The financial transaction method 400 may then depend on whether (block 408) an option from the option list 114a is selected by the electronic device 102a. If, for example, the electronic device 102a selects an offer from the offer list 114a, then the selected offer may be temporarily removed (block 410) from the list and a transaction coordination screen(s) may be displayed (block 412) on the display of the device 102a and/or on the display of a device (e.g., 102b) associated with the selected offer. The transaction coordination screen may be, in some embodiments, a map showing the geographic location of the electronic device 102a and the geographic location of a device 102b. Displaying (block 412) the transaction coordination screen may involve displaying a dynamic screen and dynamically updating the locations of the electronic device 102a and/or the electronic device 102b. In some embodiments, the geographic locations of both devices 102a and 102b in an accepted offer may be dynamically updated as the devices 102a and/or 102b attempt to move closer to one another to complete the financial transaction. In some embodiments, displaying (block 412) the transaction coordination screen may further involve a chat function, where the devices 102a and/or 102b may send messages which are displayed (block 412) to each other, to further aid in coordinating a meeting to complete the financial transaction.

In some embodiments, after a certain length of time, the method 400 may involve determining whether (block 414) the financial transaction has occurred. For example, a message may be sent to either devices 102a or 102b to determine whether the transaction has been completed. In some embodiments, a user may indicate through the device 102 that the transaction has been completed. If device 102a and/or device 102b indicates that the financial transaction has occurred, then the offers associated with the devices 102a and 102b of the completed transaction are removed (block 416) from all future option lists 114 or future updates of option lists 114. In some embodiments, if no devices 102a or 102b indicate that a financial transaction has occurred, then the offer may also be removed (block 416). Once an offer is removed (block 416), the transaction exchange (e.g., for the example device 102a) may be completed (block 418) for the two transacting devices (e.g., devices 102a and 102b).

If, in response to a query to determine whether (block 416) the financial transaction has occurred, either of the devices 102a or 102b answer that the financial transaction was unsuccessful, the device 102a may again receive (block 406) an offer list 114. The new offer list 114 may be updated in accordance with any new information or offers since the previous offer list 114, and the method 400 may continue for some time or some number of cycles or until a financial transaction is completed for the requesting device 102a.

If, in response to a query to determine whether (block 416) the financial transaction has occurred, either of the devices 102a or 102b answer that the financial transaction was unsuccessful, an offer associated with the second device (e.g., device 102b) may be added back (block 420) to the offer list. Reentering (block 420) the offer may mean that the offer associated with the device 102b may be available for selection in future offer lists 114 transmitted to other requesting and/or offering devices 102.

In some embodiments, the method 400 may then determine (block 422) whether an offer has been taken. If an offer is taken, then the method 400 may involve removing (block 410) the offer temporarily and again displaying (block 412) the transaction coordination screen. If (block 422) the offer is not taken, then the method 400 may then involve determining (block 424) whether any devices 102 have geographically moved. For example, if an offer associated with a device 102b geographically moves after beginning the financial transaction method 400 and/or after entering an offer and/or request, the method 400 may update (block 426) an offer list based on this movement. For example, the offer list 114 transmitted to a moving device 102b may be updated (block 426) based on the geographic movement of the device 102b and corresponding changes on suitable offers (e.g., an offer corresponding to device 102d may be removed from the offer list 114b if device 102b walks beyond a certain distance and/or an offer corresponding to device 102c may be added to the offer list 114b if the device 102b walks near enough to device 102c). Furthermore, in some embodiments, the offer lists 114 sent out to other devices 102 in the network 104 may also be updated (block 426) based on the geographic movement of device 102b. In accordance with the present techniques, substantially all offer lists 114 received at devices 102 may be dynamically updated (block 426) based on the geographic movement of any device 102 in the network 104.

The method 400 may allow (block 428) a device 102 in the network 104 to select an offer. If (block 422) an offer is taken, the selected offer may be temporarily removed (block 410) and the transaction coordination screen may be displayed (block 412) for the devices 102 involved in the selected offer. If (block 422) the offer is not taken, the method 400 may continue to determine (block 424) whether one or more devices 102 have geographically changed in location, update (block 426) offer lists 114 based on this movement, and allow (block 428) the offer to be selected. In some embodiments, these operations (block 424, 426, 428, and 422) may occur substantially synchronously, may overlap, and/or may occur in different orders.

In some embodiments, if a device 102a requests (block 404) a transaction and does not select (block 408) an option, then the transaction request 108a may be entered (block 430) as a new offer which may be transmitted as an offer on future outgoing offer lists 114. In some embodiments, if the device 102a requests (block 404) a transaction and does not receive any offers on an offer list 114a, then the method 400 may determine (block 408) that no option has been selected (or could be selected), and the new transaction request 108a may be entered (block 430) as a new offer.

Once the new offer is entered (block 430), the method 400 may then determine (block 424) whether any devices 102 have moved, update (block 426) offer lists 114 with new location information, and allow (block 428) an offer to be taken.

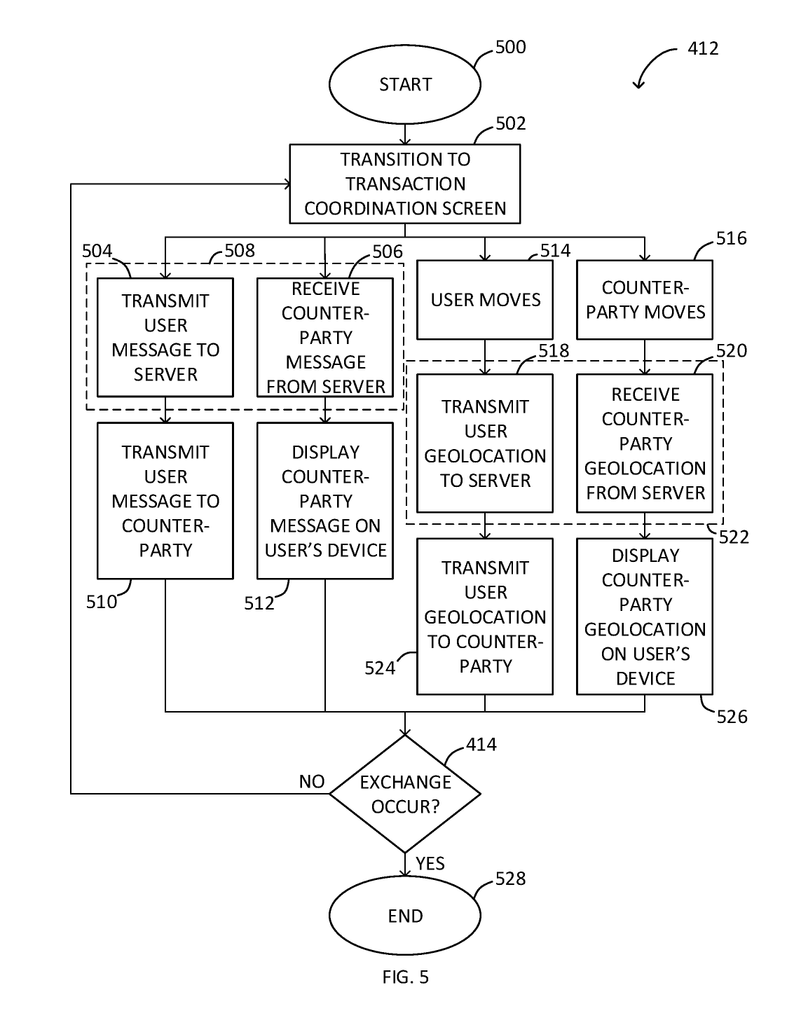

FIG. 5 illustrates flow chart of a method for dynamically updating location information between a plurality of portable electronic devices in accordance with one or more example embodiments. In some embodiments, dynamically updated location information between portable electronic devices may dynamically displayed (block 412) on the display of the device 102 as a transaction coordination screen.

The process 412 may be explained with respect to a user and a counterparty, where a user may be a user of a device (e.g., device 102a) and a counterparty may be a user of another device (e.g., device 102b) with whom the user is engaging in a financial transaction. To simplify explanations of the process 412, a device (e.g., 102a) of the user may simply be referred to as the user, and a device (e.g., 102b) of the counterparty may simply be referred to as the counterparty. Either the user or the counterparty may have accepted the other's offer such that both the user and counterparty have transitioned (block 502) to the transaction coordination screen. While the process 412 is described from the user's perspective and with respect to the user's transaction coordination screen, in accordance with the present techniques, the processes 412 and 400 and other techniques described herein may be applicable to any device communicating in the financial transaction system 100.

A process 412 for displaying a transaction coordination screen having dynamically updated location information between one or more portable electronic devices may begin (block 500) with transitioning (block 502) to the transaction coordination screen. The transaction coordination screen may be, in some embodiments, a map showing the geographic location of an electronic device 102 and the geographic location of another device 102. In some embodiments, the transaction coordination screen may include a chat interface where the user may exchange messages with the counterparty. Furthermore, in some embodiments, the transaction coordination screen may display a map with a chat interface simultaneously on the same screen, or may be toggled between a map and a chat interface.

For example, a chat function may involve transmitting (block 504) a user message to a server 106 in the financial transaction system 100. Similarly, a chat function may involve receiving (block 506) a counterparty message from the server 106. The user message may be transmitted (block 510) to the counterparty. A counterparty message may also be displayed (block 512) on the device 102a of the user. In some embodiments, the steps (block 508 as indicated by the dotted square) of transmitting (block 504) messages to a server 106 or receiving (block 506) messages at a server 106 may not be performed, as messages between devices 102 may be transmitted directly between devices 102. For example, a user may directly transmit a message to the counterparty, while a counterparty message may be directly transmitted to the user to be displayed on the device 102a of the user, without having been transmitted through a server 106.

During the process 412, the user may move (block 514), and a counterparty may also move (block 516). As the user moves (block 514), the process 412 may involve transmitting (block 518) the user's geolocation to the server 106. Similarly, as the counterparty moves (block 516), the counterparty's geolocation may be received (block 520) from the server. The user geolocation may be transmitted (block 524) to the counterparty. A counterparty geolocation may be displayed (block 526) on the device 102a of the user. In some embodiments, the steps (block 522 as indicated by the dotted square) of transmitting (block 518) the user's geolocation to the server 106 or receiving (block 520) the counterparty's geolocation from the server may not be performed, as the geolocations of the devices may be transmitted or updated directly between a user and counterparty. For example, a user may directly transmit the user's geolocation information to the counterparty, while the counterparty may directly transmit the counterparty's geolocation information to the user to be displayed on the user device 102a, without having been transmitted through a server 106.

During the process 412 of displaying a dynamically updated transaction coordination screen for one or more portable electronic devices 102, one or more of the steps of transmitting (blocks 504, 510) user messages, receiving or displaying counterparty messages (blocks 506, 512), dynamically transmitting (blocks 518, 524) user geolocation, dynamically receiving and displaying (blocks 520, 526) counterparty geolocation, etc. may be performed substantially simultaneously. For example the user and/or counterparty may be moving and transmitting and receiving messages, while transmitting and receiving dynamically refreshed geolocation information on their respective devices 102. Furthermore, in some embodiments, these operations in process 412 may occur substantially synchronously, may overlap, and/or may occur in different orders.

In some embodiments, after a certain length of time, or after an indication from the user or the counterparty, the process 412 may determine whether (block 414) the financial transaction has occurred. This determination may be made in accordance with the process 400 described with respect to FIG. 4. In some embodiments, if no exchange has occurred, the process 412 may continue with the transaction coordination screen, or may again receive (block 406) an offer list, in accordance with FIG. 4. Once a transaction has occurred, the process 412 may end (block 528).

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense and not for purposes of limitation.

1. A method, comprising:
receiving, from a portable electronic device, a request comprising requestor currency exchange information;
generating an option list based on:
the requestor currency exchange information;
a location of the portable electronic device; and
a location of potential exchangers in the option list; and
transmitting the option list to the portable electronic device, wherein the option list comprises information related to potential exchangers.

2. The method of claim 1, wherein the requestor currency exchange information comprises a first type of currency to be given in a currency exchange, a second type of currency to be received in the currency exchange, an amount of the first type of currency to be given, an amount of the second type of currency to be received, an amount range of the first type of currency to be given, an amount range of the second type of currency to be given, or combinations thereof.

3. The method of claim 1, wherein the requestor currency exchange information further comprises a currency exchange rate, a currency exchange rate range for the currency exchange, or both.

4. The method of claim 1, wherein generating the option list is further based on exchanger currency exchange information received from the potential exchangers.

5. The method of claim 4, wherein exchanger currency exchange information comprises one or more of the second type of currency to be exchanged with the first type of currency, an amount of the second type of currency to be exchanged, an amount of the first type of currency to be received, a currency exchange rate, or a currency exchange rate range for the currency exchange.

6. The method of claim 1, wherein generating the option list comprises dynamically adjusting the option list based on the location of the portable electronic device.

7. The method of claim 1, wherein generating the option list comprises dynamically adjusting the option list based on the location of potential exchangers in the option list.

8. The method of claim 1, wherein generating the option list comprises dynamically adjusting the option list based on real-time updates in the location of the portable electronic device and real-time updates in the location of the potential exchangers.

9. The method of claim 1, wherein generating the option list is based on a proximity of the location of the potential exchangers to the location of the portable electronic device.

10. The method of claim 1, further comprising displaying a transaction coordination screen on the portable electronic device, once a potential exchanger from the option list is selected by the portable electronic device, wherein the transaction coordination screen comprises dynamically updated information related to a first location of the portable electronic device and a second location of the selected potential exchanger.

11. The method of claim 10, wherein displaying the transaction coordination screen comprises displaying a dynamically updated map displaying the first location and the second location and movement of the first location and movement of the second location.

12. The method of claim 10, wherein displaying the transaction coordination screen comprises displaying a chat interface suitable for allowing exchange of messages between the portable electronic device and a potential exchanger.

13. The method of claim 12, wherein displaying the transaction coordination screen comprises displaying the dynamically updated map simultaneously with the chat interface, displaying the dynamically updated map such that it can be toggled with the chat interface, or both.

14. The method of claim 1, wherein generating the option list is performed by a processor at a server in communication with the portable electronic device and the potential exchangers, by a processor of the portable electronic device, or combinations thereof.

15. A method of facilitating a transaction between a first portable electronic device and potential transacting devices, the method comprising:
receiving, from the first portable electronic device, a first transaction request;
generating an option list based on:
the first transaction request;
transaction information from the potential transacting devices;
a location of the first portable electronic device; and
a location from the potential transacting devices;
transmitting the option list to the first portable electronic device;
displaying a transaction coordination screen on the first portable electronic device and a potential transacting device when the first portable electronic device selects the potential transacting device from the offer list; and
dynamically updating a map of the transaction coordination screen with a first geolocation of the first portable electronic device and a second geolocation of the potential transacting device.

16. The method of claim 15, comprising receiving, from one or more potential transacting devices, one or more other transaction requests.

17. A method comprising:
receiving, from a first portable electronic device, a first transaction request;
receiving, from a second portable electronic device, a second transaction request;
generating an option list based on:
the first transaction request;
the second transaction request;
a location of the first portable electronic device; and
a location of the second portable electronic device;
transmitting the option list to one or more of the first portable electronic device and the second portable electronic device.

18. The method of claim 17, comprising dynamically updating the option list based on real-time updates in the location of the first portable electronic device and real-time updates in the location of the second portable electronic device.

19. The method of claim 17, comprising:
receiving one or more additional transaction requests from one or more additional portable electronic devices;
generating the option list based on the one or more additional transaction requests and one or more locations of the one or more additional portable electronic devices; and
dynamically updating the option list based on real-time updates in the location of the one or more additional portable electronic devices;
wherein transmitting the option list comprises transmitting the dynamically updated option list to one or more of the first portable electronic device, the second portable electronic device, and one or more additional portable electronic devices.

20. The method of claim 17 comprises displaying a transaction coordination screen on the first portable electronic device and the second portable electronic device when the first portable electronic device selects the second portable electronic device from the offer list, wherein the transaction coordination screen comprises dynamically updated information related to the location of the first portable electronic device and the location of the second portable electronic device.
